(19) United States
(12) Patent Application Publication
(10) Pub. No.: US 2026/0097603 A1
(43) Pub. Date: Apr. 9, 2026

(54) METHODS, SYSTEMS, AND APPARATUSES FOR WATER-BASED INKJET PRINTING WITH MULTIPLE LAYERS OF PRIMER

(71) Applicant: ELECTRONICS FOR IMAGING, INC., Londonderry, NH (US)

(72) Inventors: Giorgio SALA, Bergamo (IT); Andrea FACHERIS, Bergamo (IT); Ernesto PROPERSI STERBIATI, Bergamo (IT)

(21) Appl. No.: 19/353,108

(22) Filed: Oct. 8, 2025

(30) Foreign Application Priority Data
Oct. 9, 2024 (IT) 102024000022470

(51) Int. Cl. B41M 5/00; B41J 11/00; B41M 7/00

(52) U.S. Cl. CPC B41M 5/0017; B41J 11/002; B41M 7/009

(57) ABSTRACT

Methods, systems, and apparatuses for water-based inkjet printing with multiple layers of primer are disclosed. A water-based inkjet printing system is configured to deposit and/or apply alternating layers of inkjet primer and water-based inkjet ink on a substrate. The system includes a printing apparatus comprising one or more primer printheads and one or more ink printheads. The system is configured to cause the printing apparatus to deposit a first layer of primer onto a substrate, apply a first layer of ink onto the first layer of primer, deposit a second layer of primer onto the first layer of ink, and apply a second layer of ink onto the second layer of primer. In some embodiments, all of the layers of primer and ink are dried contemporaneously with each other after the system has finished depositing and/or applying primer and ink.

### CROSS-REFERENCE TO RELATED APPLICATIONS

This application claims the benefit of Italian Patent Application No. 102024000022470 filed October 9, 2024, the content of which is hereby incorporated in its entirety.

### FIELD OF THE INVENTION

This description relates generally to inkjet printing, and specifically to the conveying of primer on substrates.

### BACKGROUND

The field of inkjet printing has seen significant advancements over the years, particularly in the application of various types of inks on different substrates. One of the substrates in the inkjet printing industry is cardboard, which presents unique challenges for ink adhesion and print quality. Traditionally, ultraviolet (UV) inks have been used for printing on cardboard, but water-based inks have become increasingly popular as a more environmentally friendly solution.

Water-based inks require a primer to ensure proper adhesion to cardboard surfaces. The primer creates a suitable surface for the ink to bond with, preventing issues such as ink spread and poor print quality. Currently, the application of primers in the industry is predominantly carried out using analog machines that employ rollers to press the cardboard and apply a layer of primer over the surface of the substrate. While effective, this method relies on older technology and introduces additional steps and equipment into the printing process. The need for separate primer application equipment increases operational complexity, energy consumption, and material waste.

While digital primer systems have been developed for some industrial printing applications, unique challenges persist when using water-based ink with cardboard and other paper-based materials.

### BRIEF DESCRIPTION OF THE DRAWINGS

FIG. 1 illustrates a perspective view of a printing system, in accordance with one or more embodiments.

FIG. 2 illustrates a side view of a printing system, including a printhead and a heat source, in accordance with one or more embodiments.

FIG. 3 illustrates a side view of a printing system, in accordance with one or more embodiments.

FIG. 4 is a flow diagram illustrating a method of layering primer and ink, in accordance with one or more embodiments.

FIG. 5 is a block diagram illustrating a computer system, in accordance with one or more embodiments.

### DETAILED DESCRIPTION

Methods, systems, and apparatuses for water-based inkjet printing with multiple layers of primer are disclosed. For example, the disclosed technology provides a water-based inkjet printing system configured to deposit and/or apply alternating layers of inkjet primer and water-based inkjet ink on a substrate. The system includes an inkjet printing apparatus comprising one or more primer printheads, one or more water-based ink printheads, and a substrate. The system further includes a processor and non-transitory, computer-readable storage media (e.g., a computer memory) configured to cause the printing apparatus to deposit a first layer of primer onto the substrate, apply a first layer of water-based ink onto the first layer of primer, deposit a second layer of primer onto the first layer of water-based ink, and apply a second layer of water-based ink onto the second layer of primer. In some embodiments, all of the layers of primer and water-based ink are dried contemporaneously with each other after the system has finished depositing and/or applying layers of primer and water-based ink.

The advantages and benefits of the disclosed technology include achieving higher print quality, as the primer layers can improve ink adhesion and prevent ink spread, resulting in sharper and more vibrant images. For example, by layering the primer between layers of ink, more surface area of primer becomes available for ink to react with, improving the print quality. Furthermore, the ability to dry all layers contemporaneously streamlines the printing process and can reduce the overall time required for printing. Additionally, analog printing processes require drying each layer of primer and ink before applying additional layers. This process necessitates the use of drying equipment that consumes substantial amounts of electrical power, contributing to higher CO₂ emissions from power plants. By contrast, the disclosed technology allows for a continuous printing process without the need for intermediate drying. This not only simplifies the workflow but also significantly reduces the energy consumption associated with drying equipment.

These and other aspects, features, and implementations can be expressed as methods, apparatuses, systems, components, program products, means or steps for performing a function, and in other ways. These and other aspects, features, and implementations will become apparent from the following descriptions, including the claims.

In the following description, for the purposes of explanation, numerous specific details are set forth in order to provide a thorough understanding of the present embodiments. It will be apparent, however, that the present embodiments may be practiced without these specific details.

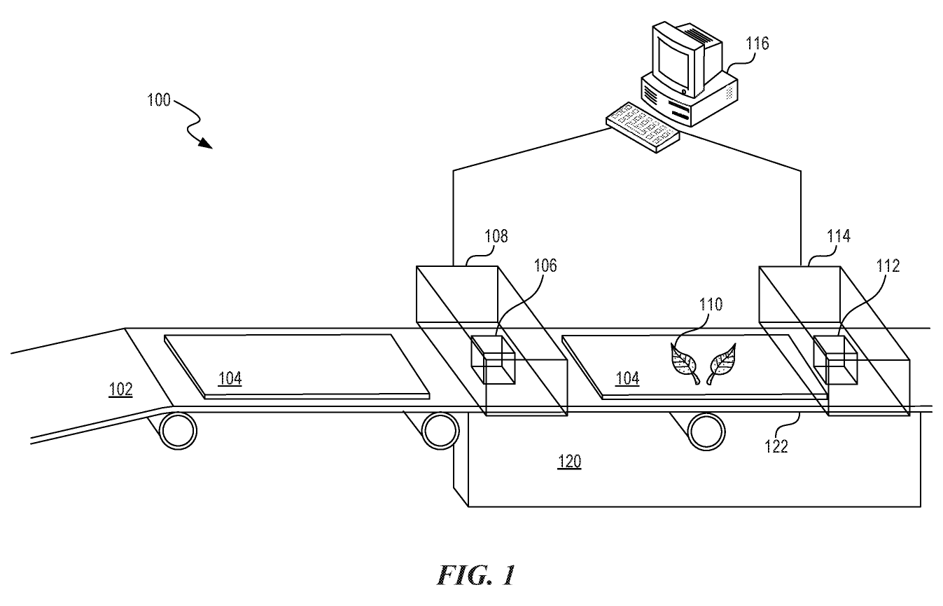

FIG. 1 illustrates a perspective view of a printing system 100, in accordance with one or more embodiments. The printing system 100 includes a printhead 106, at least one heat source 112, and a substrate transportation system 102. Embodiments may include various combinations of these and other components, e.g., a dryer. For example, the heat source 112 may be present in some embodiments, but not in others. As another example, a dryer or a fixation unit may be included if an image 110 will not be quickly transferred to a substrate. The substrate transportation system 102 can include a belt, actuators, pulleys, etc., to move the substrate. While the printing system 100 of FIG. 1 can include a transfer belt 102, other means for conveying and/or retaining a substrate or transfer material 104 can also be used, such as a rotating platform or stationary bed.

The printhead 106 is configured to deposit ink and/or primer (e.g., an acrylic-based primer compound) onto a substrate or the transfer material 104 in the form of an image 110. The substrate or transfer material 104, which may also be referred to as a former material, is flexible, which allows the image 110 to be transferred to complex-shaped substrates. For example, the substrate or transfer material 104 may be a rubber former, a thermoformable material, etc. In some embodiments, the substrate or transfer material 104 is cardboard or other paper-based material. In some embodiments, the printhead 106 is an inkjet printhead that jets ink and/or primer onto the substrate or the transfer material 104 using, for example, piezoelectric nozzles. In some embodiments, the ink is a water-based energy curable ink or solvent-based energy curable ink. The ink can be deposited in different forms, such as ink droplets and colored polyester ribbons.

In some embodiments, one or more heat sources 112 cure some or all of the ink deposited and/or applied onto the substrate or the transfer material 104 by emitting hot air or by contact between the substrate or transfer material 104 and a heating surface. The heat source(s) 112 may be, for example, a hot air blower, a convection dryer, and/or an infrared (IR) lamp. Various combinations of these and other heat sources could be used.

The printhead 106 and heat source 112 are illustrated as being directly adjacent to one another, i.e., neighboring without any intervening components. However, additional components that assist in printing, curing, etc., may also be present. For example, multiple distinct heat sources 112 may be positioned behind the printhead 106. FIG. 1 illustrates one possible order in which components may be arranged in order to print an image 110 onto the substrate or the transfer material 104. Other embodiments are considered in which additional components are placed before, between, or after the illustrated components, etc.

In some embodiments, one or more of the aforementioned components are housed within one or more carriages. For example, the printhead 106 can be housed within a printing carriage 108, the heat source 112 can be housed within a curing carriage/frame/body 114, etc. In addition to protecting the components from damage, the carriage/frame/body 114 may also provide other benefits. For example, the curing carriage/frame/body 114 can limit what portion(s) of the substrate or transfer material 104 and image 110 are exposed during the curing process. The printing system 100 may include pulleys, motors, rails, and/or any combination of mechanical or electrical technologies that enable the carriages/frames/bodies to travel along the substrate transportation system (e.g., the transfer belt 102), i.e., with respect to the substrate or the transfer material 104. The transfer belt 102 is affixed to a vacuum table 120 and moves over a vacuum platen 122 that is on top of the vacuum table 120. In alternative embodiments, the carriages can be fixedly attached to a rail or base of the printing system 100. In these embodiments, the substrate or transfer material 104 can be moved in relation to the printhead 106, heat source 112, etc., such that ink and primer can be deposited onto the substrate or transfer material 104.

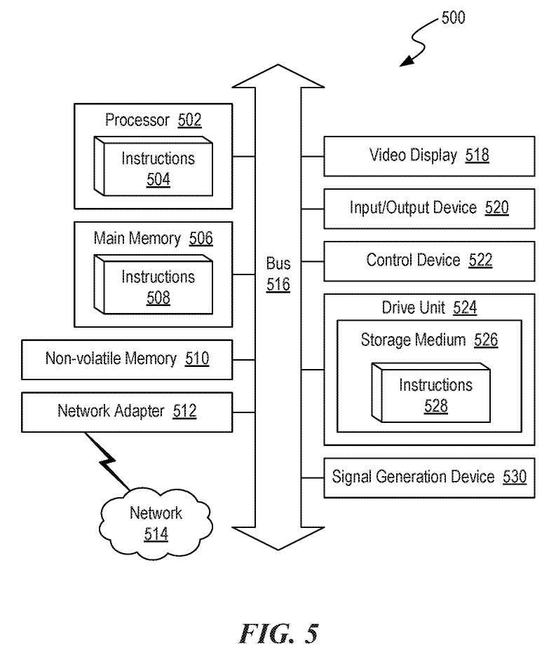

In various embodiments, some or all of the components are controlled by a computer system 116. The computer system 116 is the same as or similar to the computer system 500 illustrated and described in more detail with reference to FIG. 5. The computer system 116 can allow a user to input printing instructions and information, modify print settings, e.g., by changing cure settings, alter the printing process, etc.

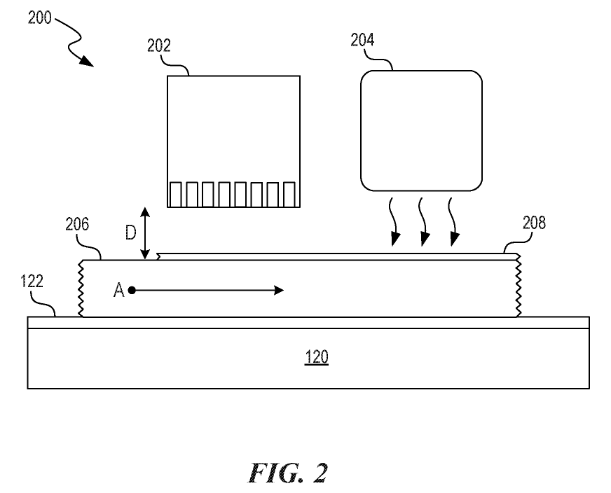

FIG. 2 illustrates a side view of a printing system 200, including a printhead 202 and a heat source 204, in accordance with one or more embodiments. While a single-pass configuration is illustrated by FIG. 2, other embodiments may employ multi-pass, i.e., scan, configurations. In some embodiments, first layers of primer and ink are deposited in a first pass, second layers of primer and ink are deposited in a second pass, etc. Similarly, embodiments can be modified for various printers, e.g., flatbed printer, drum printer, or lane printer. For example, a flatbed printer may include a stable bed and a traversing printhead, a stable printhead and a traversing bed, etc. A substrate transportation system is affixed to a vacuum table 120 and moves over a vacuum platen 122 that is on top of the vacuum table 120.

The printhead 202 can include distinct primer and/or ink/color drums, e.g., cyan, magenta, yellow, and black (CMYK), corresponding to the colored polyester ribbons that are deposited onto the surface of a substrate and/or transfer material 206. In some embodiments, one or more printheads 202 are configured to deposit and/or apply primer to the substrate 206, and one or more printheads 202 are configured to deposit and/or apply ink to the substrate 206. Path A represents the media feed direction, i.e., the direction in which the substrate or the transfer material 206 travels during the printing process. Path D represents the distance between the printhead(s) 202 and the surface of the substrate or transfer material 206. In some embodiments, the heat source 204 cures some or all of the primer and/or ink 208 deposited onto the substrate or the transfer material 206 by the one or more printheads 202.

The heat source 204 may be, for example, a hot air source, a convection source, and/or an IR lamp. Combinations of different heat sources could be used in some embodiments. Generally, the heat source 204 is selected to ensure that the curing temperature does not exceed the temperature at which the ink 208 begins to sublime.

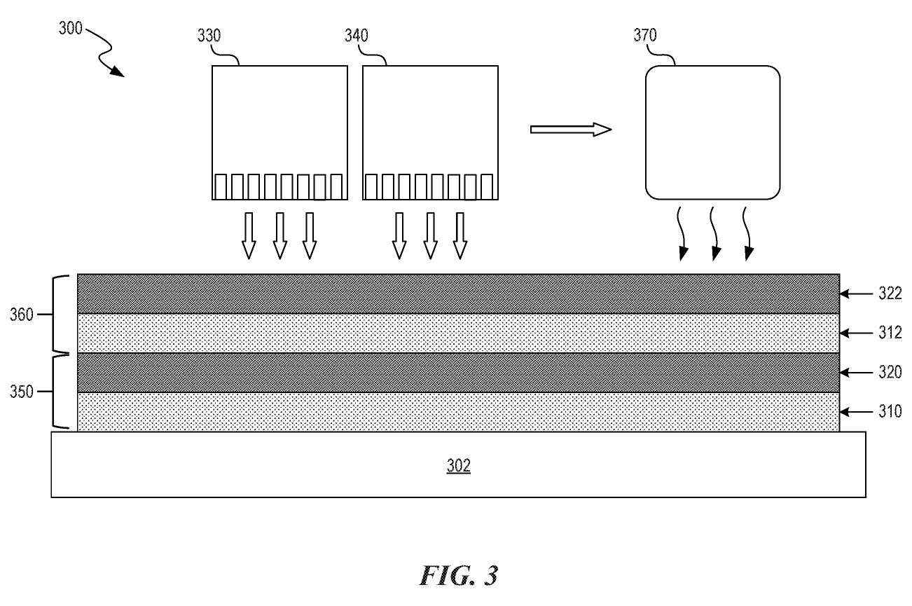

FIG. 3 illustrates a side view of a printing system 300, in accordance with one or more embodiments. In some embodiments, the printing system 300 generally includes features identical and/or similar to printing systems 100 and 200 described with reference to FIGS. 1 and 2, respectively.

The printing system 300 is a water-based inkjet printing system configured to enhance print quality and efficiency through the application of multiple layers of primer 310, 312, and water-based ink 320, 322. For example, the present embodiment is discussed in terms of two layers of primer 310, 312 alternating with two layers of water-based ink 320, 322. However, it will be appreciated by one skilled in the art that other numbers of layers of primer can be alternated with other numbers of layers of water-based ink (e.g., three alternating layers of primer and water-based ink, five alternating layers, six alternating layers, twelve alternating layers, or more). The printing system 300 comprises a substrate 302, one or more primer printheads 330 configured to deposit layers of primer 310, 312 on the substrate 302 and water-based ink 320, 322, and one or more ink printheads 340 configured to apply layers of water-based ink 320, 322 on the primer 310, 312. In some embodiments, the system is controlled by a processor (e.g., processor 502 of FIG. 5) and utilizes non-transitory, computer-readable storage media (e.g., non-volatile memory 510 of FIG. 5) storing instructions for executing the printing process.

In some embodiments, a first layer of primer 310 is deposited onto the substrate 302 via the one or more primer printheads 330. Following this, a first layer of water-based ink 320 is applied onto the first layer of primer 310 via the one or more ink printheads 340. In some embodiments, the first layer of primer 310 and first layer of water-based ink 320 are deposited and/or applied as part of a first pass 350.

In some embodiments, a second layer of primer 312 is deposited onto the first layer of water-based ink 320 via the one or more primer printheads 330. Following this, a second layer of water-based ink 322 is applied onto the second layer of primer 312 via the one or more ink printheads 340. In some embodiments, the second layer of primer 312 and second layer of water-based ink 322 are deposited and/or applied as part of a second pass 360. This layering helps ensure optimal reaction between primer and ink and improves print quality.

In some embodiments, the printing system 300 further includes one or more dryers 370 configured to dry the layers of primer 310, 312 and water-based ink 320, 322 deposited on the substrate 302. In some embodiments, the first layers of primer 310 and water-based ink 320 are dried before application of additional layers (e.g., the first pass 350 is dried prior to additional passes), and the second layers of primer 312 and water-based ink 322 are dried after drying of the first layers. That is, each pass (e.g., first pass 350, second pass 360, etc.) is dried after printing. In some embodiments, the first and second layers of primer 310, 312 are dried contemporaneously with each other and with the first and second layers of water-based ink 320, 322 via the one or more dryers 370, streamlining the process, reducing overall drying time, and conserving energy consumption from dryer 370 operation. In some embodiments, each individual layer is dried before application of additional layers. For example, the first layer of primer 310 is deposited on the substrate 302, the first layer of primer 310 is dried, the first layer of water-based ink 320 is applied to the first layer of primer 310, the first layer of water-based ink 320 is dried, etc. It will be appreciated by one skilled in the art that additional combinations of depositing primer, applying water-based ink, and drying are contemplated (e.g., the first pass 350 is deposited/applied and dried, then the second layer of primer 312 is added and dried before applying the second layer of water-based ink 322). It will also be appreciated that the order of depositing primer, applying water-based ink, and drying can be varied based on the number of layers of primer and water-based ink being used.

In some embodiments, the printing system 300 is configured to deposit one or more of the layers of primer 310, 312, and water-based ink 320, 322 based on one or more parameter values associated with the primer 310, 312 and/or water-based ink 320, 322. Parameters and/or parameter values can include coloration, intensity, detail, gradient, resolution, and quantity of primer and/or ink, to name a few. This helps ensure precise control over primer and ink application, and allows for customization/variability in printing characteristics. For example, the first layer of water-based ink 320 can include first parameter values associated with intensity, color, and quantity of ink, while the second layer of water-based ink 322 can include second parameter values associated with intensity, color, and quantity of ink. As another example, the first layer of primer 310 can include first parameter values associated with quantity of primer, and the second layer of primer 312 can include second parameter values associated with quantity of primer.

In some embodiments, the printing system 300 can determine a total parameter value associated with the first and second layers of primer 310, 312 and/or water-based ink 320, 322, allocate a first portion of the total parameter value (e.g., 50% of the total parameter value) to the first layer of primer 310 and/or water-based ink 320, and allocate a second portion (e.g., the remaining 50% of the total parameter value) to the second layer of primer 312 and/or water-based ink 322. In some embodiments, the first and second quantity values are approximately the same value, each representing about 50% of a total quantity value associated with the first and second layers of primer 310, 312 and/or water-based ink 320, 322. In other embodiments, the first quantity value is different from the second quantity value (e.g., the first layer of primer 310 is 40% while the second layer of primer 312 is 60%), allowing for customized application based on specific printing requirements.

In some embodiments, the substrate 302 is substantially comprised of paper-based material, making it suitable for a wide range of printing applications, including packaging, labels, and other paper-based products. In some embodiments, the substrate 302 is cardboard.

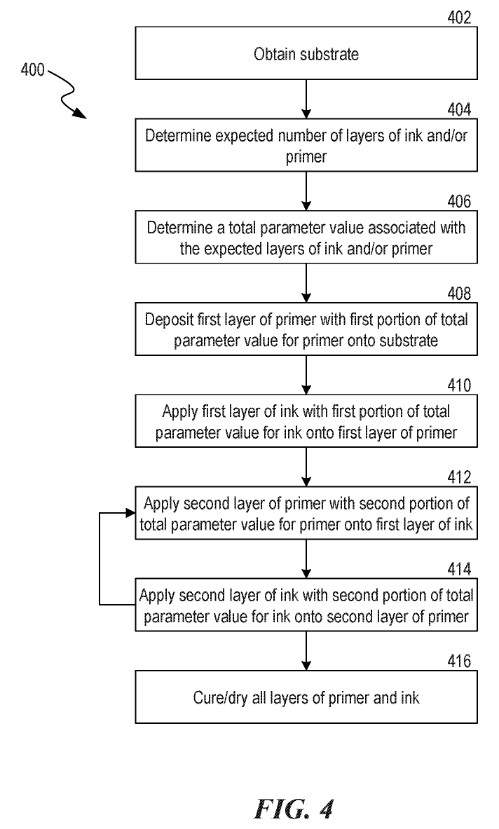

FIG. 4 is a flow diagram illustrating a method 400 of layering primer and ink, in accordance with one or more embodiments. In some embodiments, one or more of the steps of method 400 are implemented via any of the printing systems 100, 200, and 300 discussed with reference to FIGS. 1-3. In some embodiments, one or more of the steps of method 400 are implemented using the computer system 500 of FIG. 5.

At block 402, a substrate (e.g., cardboard, other paper-based material, etc.) is obtained. In some embodiments, the substrate is configured to be conveyed on an inkjet printing apparatus, similar/identical to the systems/apparatuses discussed with reference to FIGS. 1-3. For example, a conveyor belt can transport the substrate to one or more printheads that are part of a printing carriage.

At block 404, the expected number of layers of ink and/or primer are determined (e.g., two layers each of primer and ink) to accommodate the given printing needs. At block 406, one or more total parameter values associated with the expected number of layers of primer and/or ink are determined. Examples of parameter values include quantity, intensity, position relative to a coordinate plane, coloration, etc.

At block 408, a first layer of primer is deposited on the substrate. In some embodiments, the first layer of primer is deposited based at least in part on the one or more determined total parameter values. For example, a total quantity of primer can be determined, and a first portion of that quantity can be allocated to the first layer of primer deposited on the substrate.

At block 410, a first layer of ink is applied (e.g., layered) on the first layer of primer. In some embodiments, the first layer of ink is applied based at least in part on the one or more determined total parameter values. For example, a total quantity of ink can be determined, and a first portion of that quantity can be allocated to the first layer of ink applied on the first layer of primer.

At block 412, a second layer of primer is deposited on the first layer of ink. In some embodiments, the second layer of primer is deposited based at least in part on the one or more determined total parameter values. For example, a second portion of the total quantity of primer can be allocated to the second layer of primer deposited on the first layer of ink.

At block 414, a second layer of ink is applied on the second layer of primer. In some embodiments, the second layer of ink is applied based at least in part on the one or more determined total parameter values. For example, a second portion of the total quantity of ink can be allocated to the second layer of ink applied on the second layer of primer. In some embodiments, the method 400 includes applying additional layers of primer and ink in an alternating configuration (e.g., repeating blocks 412 and 414) as needed by a given printing application.

At block 416, in some embodiments, all of the layers of primer and ink are dried contemporaneously (e.g., at the end of the printing process). In some embodiments, each alternating layer of primer and ink (e.g., a first pass including the first layer of primer and the first layer of ink) is dried before additional layers of primer and ink are deposited/applied.

FIG. 5 is a block diagram illustrating a computer system 500, in accordance with one or more embodiments. Components of the example computer system 500 can be used to implement the printing systems 100, 200, and 300 illustrated and described in more detail with reference to FIGS. 1-3. At least some operations described with reference to FIG. 4 can be implemented on the computer system 500. Likewise, other embodiments can include different and/or additional components, or can be connected in a different way.

The computer system 500 can include one or more central processing units (“processors”) 502, main memory 506, non-volatile memory 510, network adapter 512 (e.g., network interface), video display 518, input/output devices 520, control device 522 (e.g., keyboard and pointing devices), drive unit 524 including a storage medium 526, and a signal generation device 530 that are communicatively connected to a bus 516. The bus 516 is illustrated as an abstraction that represents one or more physical buses and/or point-to-point connections that are connected by appropriate bridges, adapters, or controllers. The bus 516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”).

The computer system 500 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality system (e.g., a head-mounted display), or another electronic device capable of executing a set of instructions (sequential or otherwise) that specify action(s) to be taken by the computer system 500.

While the main memory 506, non-volatile memory 510, and storage medium 526 (also called a “machine-readable medium”) are each shown to be a single medium, the terms “machine-readable medium” and “storage medium” should be taken to include a single medium or multiple media (e.g., a centralized/distributed database and/or associated caches and servers) that store one or more sets of instructions 528. The terms “machine-readable medium” and “storage medium” shall also be taken to include any medium that is capable of storing, encoding, or carrying a set of instructions for execution by the computer system 500.

In general, the routines executed to implement the embodiments of the disclosure may be implemented as part of an operating system or a specific application, component, program, object, module, or sequence of instructions (collectively referred to as “computer programs”). The computer programs typically include one or more instructions (e.g., instructions 504, 508, 528) set at various times in various memory and storage devices in a computing device. When read and executed by the one or more processors 502, the instruction(s) cause the computer system 500 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 510, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 512 enables the computer system 500 to mediate data in a network 514 with an entity that is external to the computer system 500 through any communication protocol supported by the computer system 500 and the external entity. The network adapter 512 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 512 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, but no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications may be implemented by those skilled in the art.

What is claimed is:

1. A water-based inkjet printing system comprising:
an inkjet printing apparatus including:
a substrate;
one or more primer printheads configured to deposit primer on the substrate; and
one or more ink printheads configured to apply water-based ink on the primer;
a processor; and
a non-transitory, computer-readable storage media storing instructions, which, when executed by the processor, cause the inkjet printing apparatus to:
deposit a first layer of primer onto the substrate via the one or more primer printheads;
apply a first layer of water-based ink onto the first layer of primer via the one or more ink printheads;
deposit a second layer of primer onto the first layer of water-based ink via the one or more primer printheads; and
apply a second layer of water-based ink onto the second layer of primer via the one or more ink printheads.

2. The printing system of claim 1, wherein the inkjet printing apparatus further includes one or more dryers configured to dry primer and water-based ink deposited on the substrate, and wherein the non-transitory, computer-readable storage media further stores instructions, which, when executed by the processor, cause the inkjet printing apparatus to:
dry the first and second layers of primer and the first and second layers of water-based ink via the one or more dryers.

3. The printing system of claim 2, wherein the first and second layers of primer are dried contemporaneously with each other and with the first and second layers of water-based ink via the one or more dryers.

4. The printing system of claim 2, wherein the first layer of primer and the first layer of water-based ink are dried before the second layer of primer and the second layer of water-based ink are dried.

5. The printing system of claim 1, wherein the non-transitory, computer-readable storage media further stores instructions, which, when executed by the processor, cause the inkjet printing apparatus to:
deposit the first layer of primer onto the substrate based on one or more parameter values of the first layer of primer; and
deposit the second layer of primer onto the first layer of water-based ink based on one or more parameter values of the second layer of primer.

6. The printing system of claim 1, wherein the non-transitory, computer-readable storage media further stores instructions, which, when executed by the processor, cause the inkjet printing apparatus to:
determine a total parameter value associated with the first and second layers of primer;
allocate a first portion of the total parameter value to the first layer of primer to generate a first parameter value; and
allocate a second portion of the total parameter value to the second layer of primer to generate a second parameter value.

7. The printing system of claim 6, wherein the first parameter value is a first quantity value and the second parameter value is a second quantity value, and wherein the first and second quantity values are approximately the same value.

8. The printing system of claim 7, wherein each of the first and second quantity values is approximately 50% of a total quantity value associated with the first and second layers of primer.

9. The printing system of claim 6, wherein the first parameter value is a first quantity value and the second parameter value is a second quantity value, and wherein the first quantity value is different from the second quantity value.

10. The printing system of claim 1, wherein an amount of carbon dioxide emitted from power plants due to electrical power consumption by operation of inkjet printing dryers is reduced relative to conventional systems of inkjet printing.

11. A method of printing water-based ink on a substrate, the method comprising:
obtaining the substrate;
depositing a first layer of primer onto the substrate via one or more primer printheads;
applying a first layer of water-based ink onto the first layer of primer via one or more ink printheads;
depositing a second layer of primer onto the first layer of water-based ink via the one or more primer printheads;
applying a second layer of water-based ink onto the second layer of primer via the one or more ink printheads; and
curing the first and second layers of primer and the first and second layers of water-based ink via one or more dryers.

12. The method of claim 11, wherein the first and second layers of primer are cured contemporaneously with each other and with the first and second layers of water-based ink via the one or more dryers.

13. The method of claim 11, wherein the first layer of primer and the first layer of water-based ink are dried before the second layer of primer and the second layer of water-based ink are dried.

14. The method of claim 11, further comprising:
determining a total parameter value associated with the first and second layers of primer;
allocating a first portion of the total parameter value to the first layer of primer to generate a first parameter value; and
allocating a second portion of the total parameter value to the second layer of primer to generate a second parameter value.

15. The method of claim 14, wherein depositing the first layer of primer is based on the first parameter value, and wherein depositing the second layer of primer is based on the second parameter value.

16. The method of claim 14, wherein the first and second parameter values are approximately the same value.

17. The method of claim 16, wherein each of the first and second parameter values is approximately 50% of the total parameter value associated with the first and second layers of primer.

18. A non-transitory, computer-readable storage media storing instructions, which, when executed by a processor, cause an inkjet printing apparatus to:
deposit a first layer of primer onto a substrate via one or more primer printheads;
apply a first layer of water-based ink onto the first layer of primer via one or more ink printheads;
deposit a second layer of primer onto the first layer of water-based ink via one or more primer printheads; and
apply a second layer of water-based ink onto the second layer of primer via one or more ink printheads.

19. The non-transitory, computer-readable storage media of claim 18, wherein the computer-readable storage media further stores instructions, which, when executed by the processor, cause the inkjet printing apparatus to:
dry the first and second layers of primer contemporaneously with each other and with the first and second layers of water-based ink via one or more dryers.

20. The non-transitory, computer-readable storage media of claim 18, wherein the computer-readable storage media further stores instructions, which, when executed by the processor, cause the inkjet printing apparatus to:
determine a total parameter value associated with the first and second layers of primer;
allocate a first portion of the total parameter value to the first layer of primer to generate a first parameter value; and
allocate a second portion of the total parameter value to the second layer of primer to generate a second parameter value.
